(19) United States
(12) Patent Application Publication
(10) Pub. No.: US 2015/0344328 A1
(43) Pub. Date: Dec. 3, 2015

(54) METHOD AND DEVICE FOR WATER TREATMENT USING RADIO WAVES

(71) Applicant: Vladimir SUVOROV, Zvenigorod (RU)

(72) Inventor: Vladimir SUVOROV, Zvenigorod (RU)

(21) Appl. No.: 14/292,273

(22) Filed: May 30, 2014

(51) Int. Cl. C02F 1/30; C02F 1/00

(52) U.S. Cl. CPC C02F 1/30; C02F 1/008

(57) ABSTRACT

A method, device, and system for treating water solutions is disclosed for the purpose of preventing the formation of deposits on the inner surface of pipelines, boilers and other equipment. The method is based on the use of radio waves in a specific frequency range, which correspond to characteristics of the water solution under treatment. The water treatment system disclosed, and based on the method, significantly improves a water solution's properties without extensive usage of chemicals.

### FIELD OF THE INVENTION

The present invention relates to technologies for the treatment of water solutions and other fluids, particularly to the treatment of water solutions moving through pipes, pipelines, and other water-carrying equipment.

### BACKGROUND OF THE INVENTION

The treatment of water solutions with radiowave signals has a variety of applications including, but not limited to, the following: preventing or inhibiting scale formation, improving the efficiency of suspended solids sedimentation, reducing the consumption of chemicals for water treatment, and inhibiting bio-substances.

Almost all existing methods for water treatment with an electromagnetic field use a random or pseudo-random set of electromagnetic pulses in the range of radiowave frequencies of 5-38 kHz.

Two main types of such devices exist, which differ by the way that the signal is transferred into the water. There are some that use inductors reeled around the pipe (see, for example, U.S. Pat. No. 6,706,170) and others that use a magnetic core with high magnetic permeability (ferrite) (see, for example, U.S. Pat. No. 5,667,677). The disadvantage of the first mentioned method is its significantly high energy consumption during the signal transfer into the water. As a result, this undermines the efficiency of such treatment. The most effective way to transfer the energy of a radiowave signal into a fluid inside a pipe is via a ferrite core surrounding the pipe. Ferrite material has superior magnetic properties in comparison with, e.g., inductors comprising wire reeled around a pipe.

The disadvantage of the second mentioned method above, U.S. Pat. No. 5,667,677, is that it utilizes random or pseudo-random pulse sequences in a very wide range. Modulating pulses are in the range of 50-500 kHz, whereas triggering pulses are in the range of 20 Hz-20 kHz.

### SUMMARY OF THE INVENTION

One embodiment of the present invention comprises a device for treating a fluid, comprising a radiowave generator, which is attached to a pipe, or other object, containing the fluid; the generator emits a series of pulses into the fluid; these pulses correspond to radiowaves of one or more subharmonics of a resonant frequency of compounds located in the fluid. The pulses efficiently break up inorganic microcrystals growing in the fluid and adhering to surfaces of the pipe.

In second embodiment, the device further emits pulses with a second pulse rate corresponding to another set of subharmonics of the resonant frequency, thus creating at least two pulses for breaking up inorganic microcrystals.

In some embodiments, the two pulse rates are emitted sequentially, while in other embodiments, the pulse rates may be emitted simultaneously.

In some embodiments, the second pulse of subharmonics is equal to half the frequency of the first subharmonics.

Further embodiments may emit pulses with a third pulse rate corresponding to yet another set of subharmonics of the resonant frequency to further break up microcrystals located in the fluid. This frequency may be, e.g., equal to half the frequency of the second subharmonics. Again, the pulses may be emitted sequentially or simultaneously, depending on the particular embodiment. The first, second, and third subharmonics may be in the frequency ranges of 20.0-40.0 kHz, 10.0-20.0 kHz; and 5.0-10.0 kHz, respectively.

In yet other embodiments, the device further comprises a programmable microcontroller for triggering pulses to the generator, thus ensuring that the generator emits pulses at a desired rate.

The microcontroller may comprise a program for creating sequential or simultaneous pulses of various subharmonics sets to target a fluid of a particular chemical and biological composition, or fluid containing a regionally-, geographically-, or source-specific compound. The program may also adjust frequencies of emitted pulses based on temporal or seasonal change.

In some embodiments, the generator of the device further comprises a magnetic core having a plurality of detachable sections; the sections being placed around the pipe and providing for adjustment of the device's positioning on pipes based on their diameters. The detachable sections may comprise a ferrite material with a high magnetic permeability and a low electrical conductivity, thus providing for low energy loss.

Some embodiments of the device further comprise an indicator coupled to a digital display for showing the peak amplitude of induced pulses. This helps determine if the generator is correctly positioned on the pipe and if normal operation is occurring. The indicator may further comprise a control winding of an electrical wire around a magnetic core, so that a signal from the winding may be transmitted to the digital display for displaying peak amplitudes.

Also disclosed herein is a fluid treatment system, comprising a device as described by any or all of the above embodiments, and wherein at least part of the fluid passes through the device two or more times.

### BRIEF DESCRIPTION OF THE DRAWINGS

The foregoing summary, as well as the following description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 represents a device implementing the method according to the present invention.

FIG. 2 represents the connection of detachable ferrite core sections.

FIG. 3 is a circuit diagram depicting the embodiment of the device according to the present invention.

FIG. 4 is a block diagram depicting another embodiment of the water treatment facility according to the present invention.

FIG. 5 is a timing diagram of a wave signal in one embodiment of the method according to the present invention.

### DETAILED DESCRIPTION OF THE PREFERRED EMBODIMENT

Water impurities, such as calcium, magnesium, iron, and other chemical compounds, form a scale which, over time, adheres to the interior walls of water pipes. In water heaters and steam boilers the scale formation occurs even faster, which leads to the increase in energy consumption, downtime of facilities, and premature equipment wear and tear.

Water treatment using an electromagnetic field prevents the scale formation due to the fact that microcrystals of calcium carbonate (forming deposition) are transformed into a needle shaped crystal lattice (aragonite), resulting in less adhesion to the inner surfaces of pipelines and other used equipment. Some of such devices are able to transfer an electric charge of opposite polarities into the water solution to affect the suspended solids. The attraction of oppositely charged particles launches the processes of flocculation and coagulation (enlargement of suspended solids). This reduces the consumption of chemical reagents (flocculates and coagulates) and improves the functionality of filter systems.

It is possible to improve the treatment of water solutions with an electromagnetic field including more precise and selective impact on the treated objects and modifiable program of the device depending on the content of a treated fluid. All material objects consist of atoms and molecules that are oscillating. The smallest particles vibrate with the highest frequency and the oscillation frequency decreases with increased mass and complexity of objects. A resonance phenomenon occurs when the frequency of external oscillations matches the resonant frequency of the object. It is expressed through the multifold increase of the oscillation amplitude.

Research in this field shows that the precision of matching to a resonant frequency is more important than the power of the external oscillation. Accurate frequency selection creates a great resonant effect even with an extremely low power of the electromagnetic field, even with 1-10 μW/cm². Therefore, the efficiency of water solution treatment is significantly improved by the accurate selection of the frequency of an electromagnetic field matching with resonant frequencies and the subharmonics of those resonant frequencies corresponding to chemical compounds and ions from the fluid (in contrast with random frequency selection as used in prior art). Examples of chemical compounds and ions that are involved in the creation of cluster structures include, but are not limited to, Ca₂+, Ca(OH)₂, CaCO₃, CaSO₄, Mg₂+, Mg(OH)₂, MgCO₃, Fe₂+, Fe₃+, Fe(OH)₂, Fe(OH)₃, and atomic hydrogen (H+).

Most of the resonant frequencies for these chemical compounds are in the EHF (extremely high frequency) range. However, transmitting energy in the GHz range is quite challenging. The present invention propose the use of subharmonics to achieve an effect similar to that which maybe attained by using resonant GHz-range radiation.

The subharmonic frequency, f, is a fraction of a resonant frequency, F, with the following relationship: f=F/(2n), where n=positive integer numbers. Thus, the present invention affects chemical compounds and ions located in water with subharmonics in the radiowave range of 5-40 kHz (corresponding to resonant frequencies in the GHz range). In preferred embodiments of the present invention, several subharmonics are used at the same time (multiple impact, i.e. “accord”) or, alternatively, sequentially.

This invention is based on the “SPE-effect”; the affect with any resonant frequency of a water molecule is exciting the molecule on the fundamental resonant frequency of 1 GHz. Secondly, it is based on the fact that the SPE-effect exists in water solutions of inorganic compounds, including those which are insoluble in water. Additionally, the change of the water solution content with the addition of insoluble compounds shifts the fundamental resonant frequency of mixture as a whole in a unique way.

The fundamental resonant frequencies of chemical compounds may be defined and determined by various known methods, for example: (1) From open sources; (2) Calculation based on geometry, spatial models, and physical properties of a compound; (3) Using methods from bio-medicine and their equipment, such as trans-resonant functional (TRF) topographs. The principle of the TRF topograph is to affect the tested solution with EHF (extremely high frequency) emission in a particular range with a small step. A radio response of the solution is recorded. High amplitude response corresponds to the resonant frequency of the solution.

The following is an example approach for water treatment using the invention: the investigated resonance frequency (GHz) is divided by 2 several times until the frequency becomes radio frequency. Let us call this frequency as N-th harmonics. Then, by dividing by 2 again, we obtain M-th harmonics, and then by dividing by 2 once again, we obtain L-th harmonics. The water solution is treated according to the program for the investigated chemical compound and the results are analyzed.

The following is an example of how the present invention may be used for a quick assessment a water solution: The treated water solution is boiled for 1 hour and then cooled down. A visual analysis of formed micro crystals should be performed using a microscope. An additional step employing a TRF topograph may also be performed.

The program employed by a device according to the present invention may further comprise frequencies responsible for the inhibition of bacteria or protozoa. The treatment of bacteria and protozoa requires a multiple processing of the water solution. A quick assessment of the bacteria and protozoa treatment may be performed with a bacterial luminescence test-kit such as “Ecolum.”

The final program may have a set of precisely defined subharmonics, and one or several narrow frequency sub-ranges, where frequencies are formed randomly or pseudo-randomly with a deviation of 1-2% from precisely defined subharmonics. This technique is especially useful because of potential seasonal changes in the content of a water solution. Sometimes, the program may shift higher or lower from the given frequency in a very small range in small steps, using the Fuzzy Logic principle. In addition, the program and/or sub-ranges of resonant frequencies maybe corrected to correspond to the water solution content of a specific geographical region, a temporal (seasonal) change, or other specific variations.

The programmable microcontroller running the program according to one embodiment of the present invention supports at least 20 MOPS (million operations per second) in order to modulate pulses with a frequency of a certain accuracy and a simple set of resonant frequencies. More complex programs require a more powerful microcontroller with support for 40 MOPS and higher.

In addition, the transfer of the electromagnetic field into a fluid is transmitted through a magnetic core comprising ferrite with a high magnetic permeability. The ferrite core is positioned externally around the pipe or other object. This is the most effective way to transfer the energy into the solution with minimal losses. The magnetic core is preferably detachable and sectional, for convenience.

The combination of small amplitude pulses and a primary pulse is more efficient for the treatment of water solutions with an electromagnetic field, likely due to the background excitement of the fluid. Accordingly, the present invention comprises a device comprising a typical generator according to a resonant amplifier scheme. Generated frequencies are induced through a ferrite core and into a pipe with a fluid, the generated frequencies comprising pulses which are sinusoidal with exponentially decaying amplitudes. The first pulses with maximum amplitude are given the maximum energy and the decaying pulses provide the background excitement to the treated fluid. The number of cycles in the pulse may be, e.g., from 7 to 15. The fundamental frequency of the resonant amplifier in this example is 130-190 kHz.

The device further comprises an indicator, reflecting the peak amplitude of the induced signal. This is very useful as a diagnostic of proper device functionality and setup accuracy. Both are valuable for customers and/or customer service.

The device or method disclosed herein may further comprise a fluid reaction tank, an absorbent filter, a fluid pump, an air compressor, an air valve, fluid valves, a drain channel and control elements.

Two or more synchronized devices according to the present invention may be installed for water solution treatment through one or more magnetic cores around a large diameter pipeline. Additional devices may be necessary to compensate the electromagnetic field attenuation in the magnetic core.

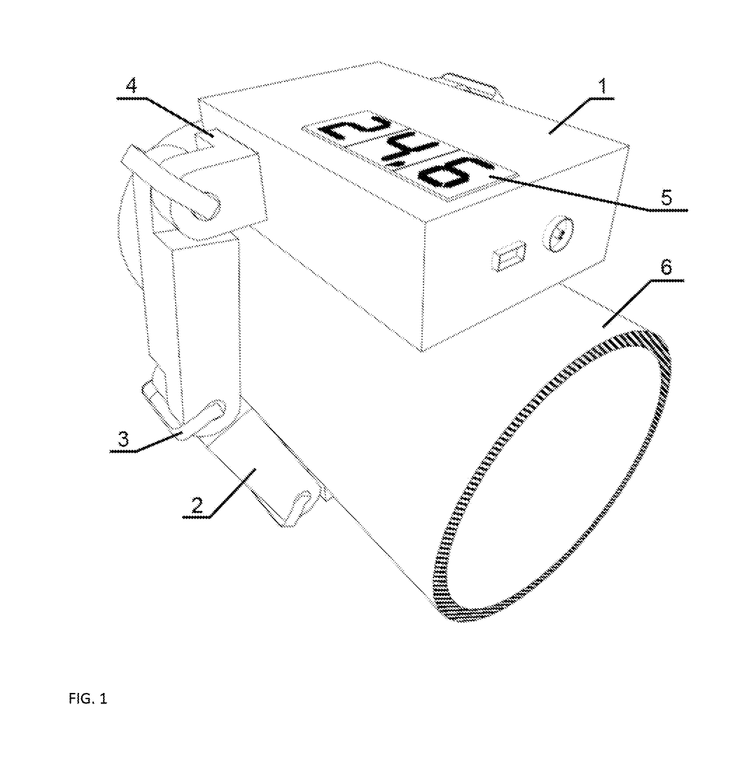

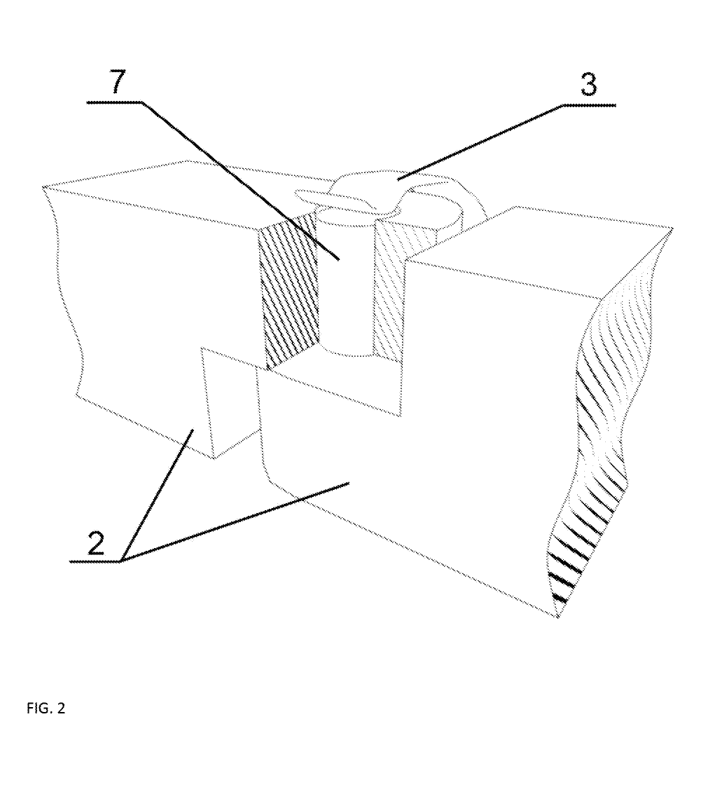

FIG. 1 represents an example device for treating a fluid, implementing the method according to the present invention. A digital display 5, showing the peak amplitude of the induced electromagnetic field, is placed on top of the device 1. The housing 1 of the device is exteriorly attached to the pipe 6 by means of detachable ferrite core sections 2 and a primary ferrite core section 4, which extends through the device housing land exits on the opposite side. The connection of ferrite sections 2 by brackets 3 is further shown in FIG. 2.

As indicated above, the device is a hardware-software complex. It maybe configured to affect the chemical compounds in water solutions with an alternative electromagnetic field. The frequencies of the electromagnetic field correspond to the subharmonics of fundamental resonant frequencies of compounds located within a fluid.

FIG. 2 shows an enlarged image of the connection of detachable ferrite core sections 2, by using hinges 7 and spring brackets 3.

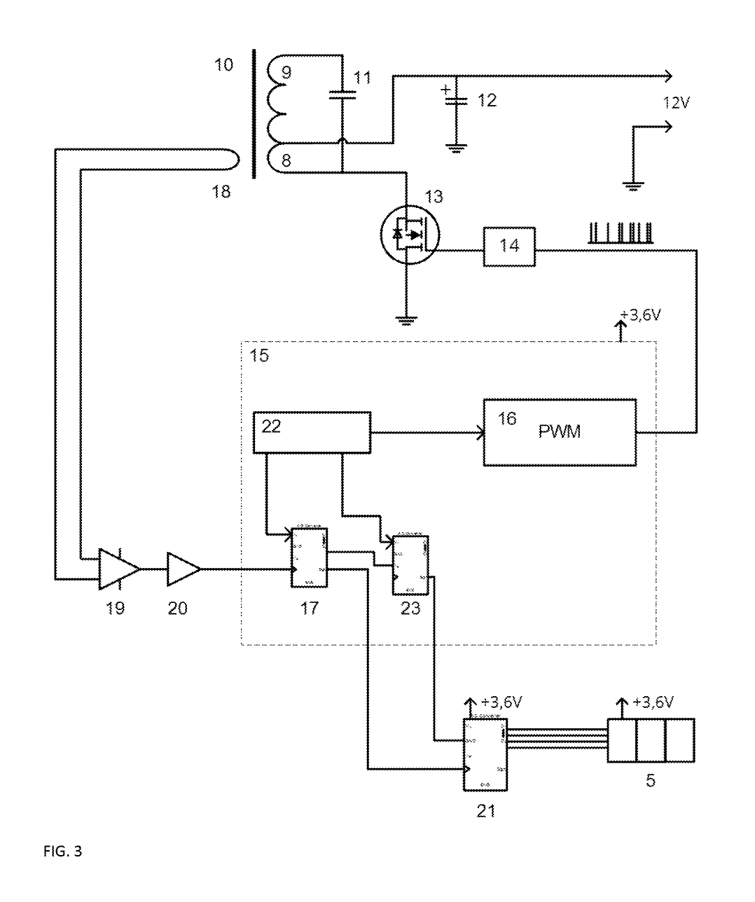

FIG. 3 shows an example circuit diagram implementing the method according to the present invention. The device is controlled by a powerful microcontroller 15, which allows the execution of the embedded programs for water solution treatment corresponding to specific content in particular geographical regions or the specific source of the fluid. The programmable microcontroller 15 modulates rectangular pulses with variable frequencies according to the embedded program, using a pulse modulator 16. The duration of the pulse is constant and approximately 3 μs. The pulse modulator 16 opens the transistor 13 of the resonant amplifier through a driver (buffer) 14. When the transistor 13 is opened, the electric current travels through the exciting generator winding 8, the winding 8 being placed around a primary section 4 (see FIGS. 1 and 2) of the ferrite core 10. Thus, an electromagnetic field is induced in the ferrite core 10 (comprising a primary section 4 and multiple detachable sections 2, thus surrounding a pipe or other object). This creates oscillations in the resonant contour: inductor 9-capacitor 11. The resonant contour forms sinusoidal pulses. At this moment, the capacitor 12 discharges and transfers additional energy to the resonant contour and increases the intensity of the initial pulse. When the transistor 13 is closed, the external power to the resonant contour energy is cut off, and oscillations in the contour slowly decay.

Continuing with FIG. 3, the device further comprises a monitoring circuit that monitors the amplitude of the alternative voltage. The signal emitted from a control winding 18, which is coupled to the ferrite core 10 is transmitted to an operational amplifier 19, then to a filter and peak detector 20, and then to the microcontroller 15. Once within the microcontroller 15, the monitoring circuit signal is digitized by an ADC (analog-digital converter) 17, further analyzed (comparing the obtained amplitude with a predetermined threshold) by the control unit 22 and transferred to the display controller 21, and finally transmitted to the digital display 5, thus allowing the indicator to reflect the oscillation amplitude in digital form. A comparator 23 is also included for catching signals which may cause an error, which are labeled as such before being transmitted to the display controller 21 and digital display 5.

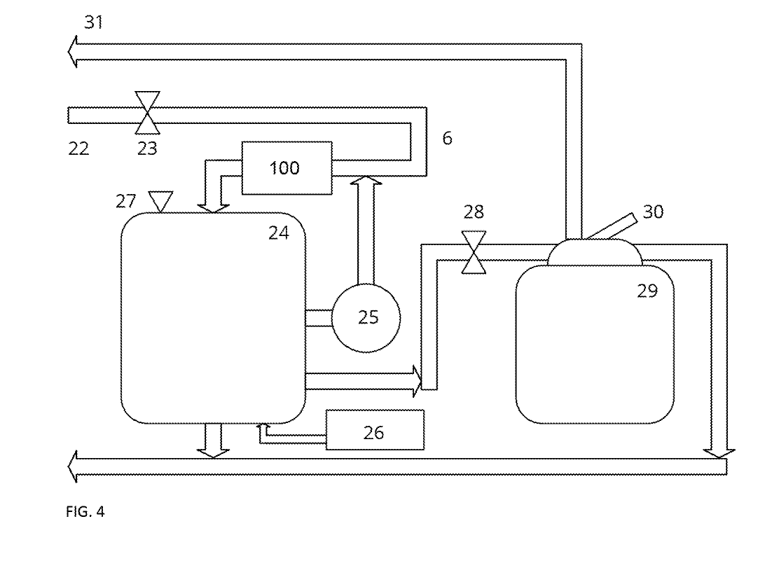

FIG. 4 shows an example block diagram of a water treatment facility employing the method of the present invention. The method comprises a device according to the present invention 100, positioned along a pipe 6 between the input stream of fluid 22 and the fluid reaction tank 24. The method further comprises an absorbent filter 29 with quartz sand or similar, a fluid pump 25 providing multiple circulation of water, an air compressor 26, an air valve 27, fluid valves 23 and 28, a drain channel 30, an output (i.e. treated) stream of fluid 31, and control elements. The fluid pump 25 provides a multiple circulation of the treated water solution through the device 100. When the fluid has an excessive amount of dissolved iron (Fe²⁺), the air compressor 26 injects oxygen (from the air) into the bottom part of the fluid reaction tank 24. The air is necessary for intensive oxidizing of iron ions. The excessive air is removed from the fluid reaction tank 24 through the air valve 27. The treatment of water solutions by the device 100 promotes the coagulation and flocculation of suspended solids and the intensive oxidizing of iron ions. Iron oxides and suspended solids are easily filtered with the absorbent filter 29. The absorbent filter based on quartz sand (or the like) improves the efficiency of coagulation due to the contact coagulation effect. The absorbent filter 29 should be cleaned periodically using the drain channel 30.

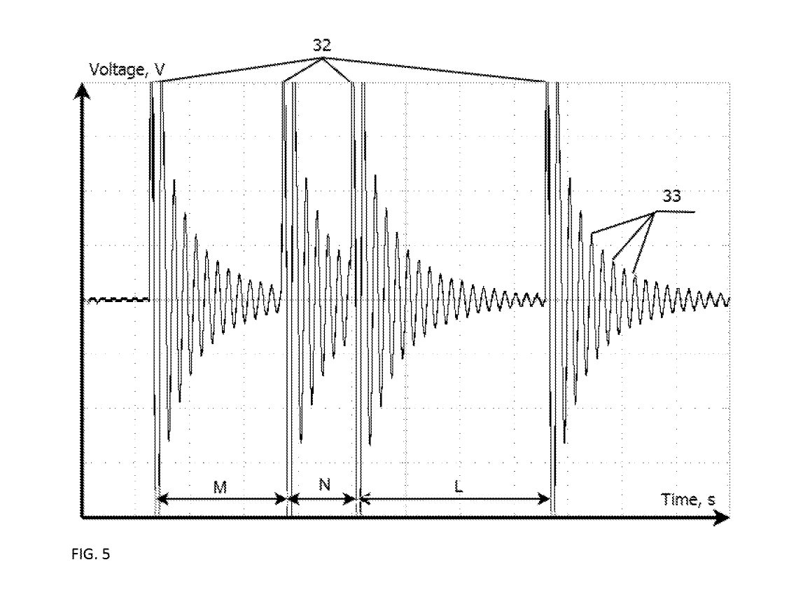

FIG. 5 shows a graph of the waveform of a voltage induced in the ferrite core 10. Initial pulses 32 with maximum intensity corresponding to the subharmonics of resonant frequencies are the major impact on the treated fluid. Time M corresponds to the M-th subharmonic, time N corresponds to the N-th subharmonic and time L corresponds to the L-th subharmonic. Decaying pulses are marked as 33. Thus, initial pulses 32 may form an “accord” together with the next sequence of pulses.

The present invention provides for a significantly improved cleaning and treatment efficiency in comparison with analogs, due to the precise and selective impact on compounds via use of subharmonic frequencies and combinations thereof. The program creating the sequence of pulses is also very flexible and is not random, thus also improving upon the prior art. The program further allows for the ability to implement several approaches for pulse sequences. Finally, the digital indicator additionally provides a way to check the efficiency of the treatment and further acts as a useful troubleshooting tool.

The description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What is claimed is:

1. A device for treating a fluid, comprising:
a radiowave generator attached to a pipe containing a fluid; the generator emitting a series of pulses into the fluid within the pipe; a first pulse rate corresponds to one or more N-th subharmonics in a radiowave range of a resonant frequency of one or more compounds within the fluid; the resonant frequency being in a GHz range;
the pulses efficiently affecting inorganic microcrystals growing in the fluid and on an internal surface of the pipe, the pulses changing the microcrystals' shape thus reducing microcrystal adhesion to surfaces touched by the fluid.

2. The device of claim 1, wherein the generator emits pulses with a second pulse rate corresponding to M-th subharmonics of the resonant frequency; the pulses with M-th subharmonics rate being emitted into the fluid and affecting the microcrystals in the same manner as that of claim 1.

3. The device of claim 2, wherein N-th and M-th subharmonics are emitted sequentially.

4. The device of claim 2, wherein N-th and M-th subharmonics are emitted simultaneously.

5. The device of claim 2, wherein a frequency of M-th subharmonics is equal to half of a frequency of the N-th subharmonics.

6. The device of claim 2, wherein the generator emits pulses with a third pulse rate corresponding to L-th subharmonics of the resonant frequency; the pulses with L-th subharmonics rate being emitted into the fluid and affecting the microcrystals in the same mariner as that of claim 2.

7. The device of claim 6, wherein a frequency of L-th subharmonics is equal to half of a frequency of M-th subharmonics.

8. The device of claim 6, wherein N-th, M-th, and L-th subharmonics are emitted sequentially in a predetermined sequence of any order.

9. The device of claim 8, wherein N-th, M-th, and L-th subharmonics are in frequency ranges of 20.0-40.0 kHz, 10.0-20.0 kHz; and 5.0-10.0 kHz, respectively.

10. The device of claim 1, further comprising a programmable microcontroller that provides triggering pulses to the generator, thus ensuring that the generator emits pulses at a desired rate.

11. The device of claim 10, wherein the microcontroller provides pulses to the generator for emitting pulses of N-th, M-th, and L-th subharmonics sequentially, thus providing a sequence of generated N-th, M-th and L-th subharmonics targeting the fluid.

12. The device of claim 11, wherein a program is created and stored within the microcrontroller, which is based on a specific chemical and biological composition of the fluid being treated.

13. The device of claim 12, wherein the fluid is a water solution, and wherein the program is adjusted for a regional or geographic content within the water solution.

14. The device of claim 13, wherein the program is specifically created for one particular source of water solution.

15. The device of claim 12, wherein the program adjusts all frequencies based on a temporal or seasonal change of the fluid.

16. The device of claim 1, wherein the generator further comprises a magnetic core having a plurality of detachable sections; the sections being placed around the pipe; the sections providing for adjustment of device positioning on pipes with varying diameters.

17. The device of claim 16, wherein the sections comprise a ferrite material with a high magnetic permeability and a low electrical conductivity, wherein the ferrite material provides a low energy loss.

18. The device of claim 1, further comprising an indicator; the indicator being coupled to a digital display for showing a peak amplitude of induced pulses thus determining a correct placement of the generator on the pipe and a normal operation if the shown amplitude is above a predetermined threshold.

19. The device of claim 18, wherein the indicator further comprises a control winding of an electrical wire around a magnetic core, wherein a signal from the winding is transmitted to the digital display for showing the peak amplitude of induced pulses.

20. A fluid treatment system, comprising: a device for fluid treatment, the device comprising a radiowave generator; the generator emitting a series of pulses into the fluid; a first pulse rate corresponds to N-th subharmonics in the radiowave range of a resonant frequency of the fluid; the resonant frequency being in GHz range;
the pulses efficiently affect organic and inorganic impurities in the fluid thus improving the fluid quality, wherein at least a part of the fluid passes through the device at least twice.
